(19) United States
(12) Patent Application Publication
(10) Pub. No.: US 2012/0045542 A1
(43) Pub. Date: Feb. 23, 2012

(54) PROCESS TO PRODUCE A WINE OR FRUIT JUICE STABLISER

(75) Inventor: Peter Philip Lankhorst, Rotterdam (NL)

(73) Assignee: DSM IP ASSETS B.V., Heerlen (NL)

(21) Appl. No.: 13/318,214

(22) PCT Filed: May 17, 2010
(86) PCT No.: PCT/EP2010/056726

§ 371 Date: Oct. 31, 2011

(30) Foreign Application Priority Data
May 18, 2009 (EP) 09160499.1

(51) Int. Cl. A23J 3/34; A23J 1/00; A23L 1/48; C12G 1/00; A23L 2/02

(52) U.S. Cl. 426/7; 426/592; 426/599; 426/654; 426/656

(57) ABSTRACT

The present invention relates to a process to produce a wine or fruit juice stabiliser comprising contacting a composition comprising proteinaceous material with a prolyl-specific protease, as well as to a wine or fruit juice stabiliser obtainable by said process. The invention also relates to a composition comprising peptides, said peptides having a molar fraction (%) of peptides carrying a carboxy terminal prolyl residue of at least 0.25%. Said wine or fruit juice stabiliser or composition may be used as a stabiliser against the crystallisation of KHT or other organic acids without causing protein haze.

### FIELD OF THE INVENTION

The present invention relates to a process to produce a wine or fruit juice stabiliser comprising contacting a composition comprising proteinaceous material with a prolyl-specific protease as well as to a wine or fruit juice stabiliser obtainable by said process. The invention also relates to a composition comprising peptides, said peptides having a molar fraction (%) of peptides carrying a carboxy terminal prolyl residue of at least 0.25%, and to a process to stabilize wine or fruit juice by preventing or retarding the crystallisation of KHT or other organic acids wherein said wine or fruit juice stabiliser or composition is added to said wine or fruit juice. The invention also relates to wine or fruit juice comprising said wine or fruit stabiliser or composition.

### BACKGROUND OF THE INVENTION

Tartaric acid is the main organic acid produced by the grape berry during its development. In wine making, during fermentation of the must the solubility of salts of tartaric acid decreases with the increase of ethanol concentration. In young wines, potassium hydrogen tartrate (KHT) is always present in supersaturated concentrations and crystallises spontaneously. After bottling wine the KHT-instability may become a problem due to the unpredictable character of the crystallisation: consumers often perceive the presence of crystals in the bottle as a sign of inferior quality of the wine. Physical treatments can be used prior to bottling of the wine to prevent crystallisation of tartrate salts. These treatments consist of promoting crystallisation by cooling the wine to −4° C. or of eliminating the potassium and tartaric ions by electrodialysis or by using ion-exchange resins. However, these time- and energy-consuming processes are supposed to alter the colloidal equilibrium of wine. Also in other fruit-derived beverages such as fruit juices, formation of KHT crystals or crystals of other organic acids may occur.

The alternative to such physical treatments of wine or fruit juice is to use wine stabilisers preventing the nucleation and/or the growth of crystals of KHT crystals. WO2006/067145 describes a mannoprotein which is fully soluble in wine which can be used as a wine stabiliser. WO2008/128972 describes a wine stabiliser composition comprising at least 2.5% of a peptide mixture with a molecular weight between 3 kDa and 10 kDa.

However, wine or fruit juice stabilisers, particularly wine stabilisers comprising proteins and/or peptides, may have the disadvantage that, once added to the wine or fruit juice, they may react with polyphenols present in said wine or fruit juice resulting in undesirable turbidity. Such turbidity is sometimes referred to as protein haze. Polyphenols are compounds having a chemical structure containing at least two aromatic rings substituted with at least one hydroxyl group or having a chemical structure containing at least one aromatic ring substituted with at least two hydroxyl groups. Examples of such polyphenols are tannins and flavonoids, which include for example catechins, flavonols and anthocyanins. Tannins are defined herein according the International Oenological Codex (Oenological tannins, E-COEI-1-TANNIN 1, Oenological Tannins INS N°: 181) as a mixture of glucosides either from gallic acid (gallotannins) or from dilactone, ellagic acid (ellagitannin, hydrolysable tannins) or from a mixture of proanthocyanidines (condensed tannins). A wine or fruit juice with protein haze is not appreciated by the customer and may be interpreted as a sign of inferior quality of the wine. Furthermore, if a proteinaceous stabiliser reacts with polyphenols in the wine or fruit juice to form a protein haze, said stabiliser is no longer in solution, which reduces the efficacy of the stabiliser against crystallisation of KHT.

There is a need for wine or fruit juice stabilisers, particularly stabilisers for wine or fruit juice comprising proteinaceous material, that can prevent or retard the crystallisation of KHT without causing protein haze.

### DETAILED DESCRIPTION OF THE INVENTION

In a first aspect the invention provides a process to produce a wine or fruit stabiliser comprising contacting a composition comprising proteinaceous material with a prolyl-specific protease.

“Proteinaceous material” is defined herein as any material comprising amino acids, peptides, or proteins, or a mixture thereof. A peptide is defined herein as a compound comprising two or more amino acids which are linked through peptide bonds. In this text, the words peptide and protein are used interchangeably. The amino acids, peptides, and/or proteins may further be linked, either covalently or non-covalently, to carbohydrate and/or lipid moieties. For example, they may be linked to mannan residues. The proteinaceous material comprises proline residues.

It has been surprisingly found that contacting a composition comprising proteinaceous material with a prolyl-specific protease may produce a wine or fruit juice stabiliser which when added to the wine or fruit juice in an effective amount may stabilize said wine or fruit juice by preventing or retarding the crystallisation of KHT and which may cause less formation of protein haze as compared to a composition comprising proteinaceous material which has not been contacted with a prolyl-specific protease. A wine or fruit juice with no or little protein haze may be better appreciated by the customers than a wine or fruit juice with protein haze.

In the context of the invention “protein haze” shall refer to any precipitation, aggregation, and/or flocculation in wine or fruit juice, which said precipitation, aggregation, and/or flocculation comprises proteinaceous material. In an embodiment preferably protein haze occurs through interaction of proteinaceous material with polyphenols.

The wine or fruit juice stabiliser produced with the process according to the first aspect, when added to a wine or a fruit juice may not react, or may react to a lesser extent, with polyphenols present in the wine or fruit juice, but may instead stay in solution, which may result in an increase of the efficacy of said stabiliser against crystallisation of KHT as compared to adding a stabiliser which causes protein haze.

The proteinaceous material may be derived from animal origin such as whole milk, skim milk, casein, whey protein or mixtures of casein and whey protein, or from plant origin such as, for example wheat gluten, soy milk, corn, rice, and pea. The proteinaceous material is preferably derived from yeast, preferably from Saccharomyces cerevisiae. More preferably, the proteinaceous material is mannoprotein. “Mannoprotein” is defined herein according to Resolution Oeno 26/2004 of the OIV (Organisation Internationale de la Vigne et du Vin) as a product which can be extracted from Saccharomyces cerevisiae cells and/or yeast cell walls by physico-chemical or enzymatic methods. Mannoproteins are different structures depending on their molecular weight, their degree and type of glycosylation, and are known to be effective as a stabiliser. WO2008/128972 describes a wine stabiliser composition comprising at least 2.5% of a peptide mixture with a molecular weight between 3 kDa and 10 kDa, as determined by GPC as described in the materials and methods section of WO2008/128972. Therefore, in a preferred embodiment, the proteinaceous material of the process of the first aspect of the invention comprises a peptide mixture with a molecular weight ≧3 kDa and ≦10 kDa and wherein the amount of said peptide mixture is at least 2.5% w/w relative to said composition based on total dry weight, wherein the molecular weight is determined by GPC as described in the materials and methods section of WO2008/128972.

The composition comprising proteinaceous material and/or the wine or fruit juice stabiliser produced by the process according to the first aspect of the invention may further comprise one or more biomolecules such as carbohydrates, lipids, fatty acids, and/or oligonucleotides.

In an embodiment, the composition comprising proteinaceous material is itself a stabiliser for wine or fruit juice, which may be a stabiliser which, once added to the wine or fruit juice, results in formation of protein haze. Treating said stabiliser with a prolyl-specific protease according to the process of the first aspect of the invention may result in a stabiliser which may retain its efficacy as a stabiliser, yet which, once added to the wine or fruit juice, may cause no, or little, protein haze.

Throughout the description of the invention “wine” may be understood to encompass wine before or after bottling as well as must at the end of the alcoholic fermentation, and wine during aging.

A “fruit juice” means a beverage made from fruit. It is preferably a clear solution, e.g. obtained after filtration.

Any wine or fruit juice may be stabilised by the stabiliser produced by the process of the invention. Preferably the wine is aged on oak. In a preferred embodiment the wine is a red wine. Red wines are usually richer in tannins than white or rosé wine, which tannins readily react with proteinaceous material to form turbidity. However, also white or rosé wines may be suitably stabilised, for example white or rosé wines which are aged on oak, such as oak aged chardonnay.

The wine or fruit juice stabiliser produced according to the process of the first aspect of the invention may be effective in preventing or retarding the crystallisation of potassium salts of tartaric acid, or crystals of other organic acids which may be present in wine or fruit juice.

A “proline-specific protease” is defined herein as a protease which has a preference to cleave a peptide bond adjacent to a proline residue in a peptide chain, either at the carboxy-terminal side of the proline residue or at the amino-terminal side of the proline residue. The proline-specific protease may be a proline-specific exoprotease or a proline-specific endoprotease. Preferably, the proline-specific protease is a proline-specific endoprotease. Proline-specific endopeptidases include proline-specific oligopeptidases. Proline-specific oligopeptidases have a preference to cleave a peptide bond adjacent to a proline residue in peptide chains of about 30 aminoacids or less, for example 30 aminoacids or less. Examples of prolyl-oligopeptidases are prolyl-oligopeptidases belonging to the class EC 3.4.21.26. More preferably, the proline-specific protease is a proline-specific endoprotease derived from fungi, more preferably from the genus Aspergillus, most preferably Aspergillus niger. The latter organism is widely known as a food grade microorganism. Most preferably the proline-specific protease is a proline-specific endoprotease which cleaves at the carboxyterminal side of proline.

Examples of suitable fungal proline-specific endoproteases are those disclosed in WO02/45524. Surprisingly, we have found that the proline-specific endoproteases described in WO02/45524 may be used to treat compositions comprising proteinaceous material to produce a wine or fruit juice stabiliser which, when added to wine or fruit juice, may prevent or retard the crystallisation of KHT, but which may lead to no or little protein haze. Most preferred is the specific proline-specific endoprotease referred to in claims 1-5, 11 and 13 of WO02/45524.

The proline-specific protease may be isolated via methods known in the art. For instance, proline-specific endoprotease may be isolated from culture broths obtained from (large scale) fermentation processes wherein the proline-specific endoprotease-producing microorganism, such as Aspergillus niger, is grown. In a preferred embodiment, the proline-specific protease is isolated from a microbial host that is genetically engineered in order to over-express a gene encoding the proline-specific protease. Suitable hosts known in the art are bacteria (i.e. of the genus Bacillus, Escherichia etceteras), yeasts (i.e. of the genus Saccharomyces or Kluyveromyes) or fungi (i.e. from the genus Aspergillus, such as Aspergillus niger, Aspergillus oryzea and others known in the art). Most preferred is the over-expression of the gene encoding an Aspergillus niger proline-specific endoprotease by an engineered Aspergillus niger host.

The specificity of a proline-specific protease can be determined by methods that are generally known to the person skilled in the art. For example, the activity of proline-specific proteases that cleave at the carboxy-terminal side of proline, can be measured by using the synthetic peptide Z-Gly-Pro-pNA (Z=benzyloxycarbonyl) as a substrate while monitoring the formation of the yellow coloured para-nitroanilide (pNA). The activity of proline-specific proteases that cleave at the amino-terminal side of the proline residue can be identified using for example the synthetic substrate FA-Pro-Ala-Ala (FA=3-(2-furylacryloyl)) and whereby the carboxy-terminus of the substrate preferentially is blocked by methods known in the art. The activity of proline-specific proteases that cleave in between two adjacent proline residues can be identified using for example an internally quenched fluorogenic substrate such as HOO-E-(EDANS)-PPPPK-(DABCYL)-NH2 according to the method described by Matayoshi et al (1990), Science 247, 954-958. In this substrate, the fluorescent donor (EDANS) is linked to the side chain carboxyl group of the N-terminal glutamic acid and the fluorescent quenching acceptor (DABCYL) is linked to the side chain amino group of the C-terminal lysine.

As with any enzyme, the prolyl-specific protease of the process of the first aspect of the invention requires water for its hydrolytic activity. Therefore, in a preferred embodiment, the composition comprising proteinaceous material in the process according to the first aspect of the invention is a liquid composition. A liquid composition is defined herein as a solution, preferably an aqueous solution, of the composition comprising proteinaceous material.

In a preferred embodiment the temperature of the process of the first aspect of the invention may be between 5 and 120° C. More preferably the temperature is between 10 and 80° C., more preferably between 20 and 75° C., even more preferably between 40 and 70° C. At higher temperature enzymes reactions proceed faster. However, above certain temperatures, which are specific for any enzyme, enzymes tend to inactivate. Above 120° C. most known enzymes will inactivate. Below 5° C. most enzymes are not active, or only to a small extent.

The pH of the process according to the invention may be anywhere between 2 and 10, preferably between 3 and 9. Most known prolyl-specific proteases are active around pH 8, such as from Flavobacterium (EP 0 967 285), Aeromonas (J. Biochem. 113, 790-796), Xanthomonas, and Bacteroides. The prolyl-specific endoproteases from Aspergillus niger is active around pH 5 (EP 0 522 428).

The contacting of the process according to the first aspect of the invention may be carried out for a time period ranging between 1 minute and 1 month, more preferably between 5 minutes and 1 week, more preferably between 30 minutes and 1 day.

The amount of prolyl-specific protease in the process of the first aspect of the invention may vary between wide limits. In a preferred embodiment the amount of prolyl-specific protease is between 0.001 and 1000 units of prolyl-specific protease activity per gram proteinaceous material, whereby the activity is determined by an activity measurements using Z-Gly-Pro-pNA as a substrate, more preferably between 0.01 and 100 units/gram proteinaceous material, more preferably between 0.1 and 10 units/gram proteinaceous material.

The amount of prolyl-specific protease in the treatment is preferably such that a wine or fruit juice stabiliser is produced which, once added to the wine or fruit juice, may prevent or retard the crystallisation of KHT whilst causing no or little protein haze, and may depend on the temperature and pH of the composition comprising proteinaceous material, as well as on the time period of the treatment of proteinaceous material in the composition. For example, when the treatment is done at or near a temperature and/or pH at which the prolyl-specific protease displays optimal enzyme activity (Tₒₚₜ and pHₒₚₜ) the amount of prolyl-specific protease may be less in order to produce the desired stabiliser for wine or fruit juice of the invention. When the treatment is done at a temperature significantly below Tₒₚₜ, e.g. more than 10° C. below Tₒₚₜ, and/or at a pH which is significantly lower or higher than the pHₒₚₜ, e.g. more than 1 pH unit away from pHₒₚₜ, the concentration of prolyl-specific protease may be higher in order to produce the desired stabiliser for wine or fruit juice of the invention. Likewise, when the treatment time for a short period, and/or when the amount of the proteinaceous material in the composition comprising proteinaceous material is high, the amount of prolyl-specific protease may be higher in order to produce the wine or fruit juice stabiliser of the invention, whereas when the treatment time is for a longer period, and/or when the content of the proteinaceous material in the composition comprising proteinaceous material is lower, the amount of prolyl-specific protease may be lower in order to produce the wine or fruit juice stabiliser of the invention. The skilled person may therefore, without undue burden, establish suitable conditions with respect to the amount of prolyl-specific protease in relation to the temperature and pH of the composition comprising proteinaceous material, the time of treatment, and the content of the proteinaceous material in the composition comprising proteinaceous material in order to produce the desired wine or fruit juice.

The process of the first aspect of the invention optionally includes an inactivation step after the contacting step, for the purpose of inactivating the prolyl-specific protease. The inactivation is preferably done by heating, more preferably by boiling the composition of the process according to the first aspect of the invention. Boiling advantageously may cause precipitation of the (inactivated) prolyl-specific protease. Optionally the process according to the first aspect of the invention may include a solid-liquid separation step after the contacting step, for example by centrifugation or by filtration. Preferably, the process according to the first aspect of the invention includes, after the contacting step, firstly an inactivation step and secondly a solid-liquid separation step. By inactivating the prolyl-specific protease, the contacting of the active enzyme with the composition comprising the proteinaceous material may be controlled such that a wine or fruit juice stabiliser is produced which, once added to the wine or fruit juice, may prevent or retard the crystallisation of KHT whilst causing no or little protein haze. If the contacting of the active prolyl-specific protease with the composition comprising the proteinaceous material proceeds for too long, the desired wine or fruit juice stabiliser may not be obtained, for example because the proteinaceous material has been cleaved to a too large an extent by the prolyl-specific protease, which may lead to loss of the efficacy as a wine or fruit juice stabiliser. Removal of solids may result in a purer wine or fruit juice stabiliser and may avoid adding the (inactivated) prolyl-specific protease to the wine or fruit juice which otherwise might be added concomitantly with the wine or fruit juice stabiliser to the wine or fruit juice.

Preferably the prolyl-specific protease of the process according to the first aspect of the invention is an isolated or purified prolyl-specific protease. An “isolated” or “purified” prolyl-specific protease is defined herein as a prolyl-specific protease which is isolated from its native environment. For example, recombinantly produced prolyl-specific proteases expressed in host cells are considered isolated for the purpose of the invention as are native or recombinant prolyl-specific proteases which have been purified to some extend by any suitable technique known in the art. The purified and/or isolated prolyl-specific protease preferably contains little or no undesired contaminating components which might otherwise interfere with the composition comprising proteinaceous material during the treatment. For example, the presence of proteases other than the prolyl-specific protease together with the prolyl-specific protease may break down the proteinaceous material during the treatment, such that the efficacy of the stabiliser against the crystallisation of KHT may be diminished or lost.

In a second aspect the invention provides a wine or fruit juice stabiliser obtainable by the process according to the first aspect of the invention. The wine or fruit stabiliser of the second aspect of the invention preferably comprises peptides, more preferably yeast peptides, even more preferably peptides from Saccharomyces, most preferably peptides from Saccharomyces cerevisiae. In the context of the invention, “peptides” are understood to include also glycopeptides such as for example mannoprotein. The peptides of the wine or fruit stabiliser of the second aspect of the invention are preferably enriched in terminal prolyl residues, preferably in carboxy-terminal prolyl residues, as compared to the peptides of the proteinaceous material prior to the contacting with the prolyl-specific protease in the process of the first aspect of the invention. The wine or fruit juice stabiliser of the second aspect of the invention may be used as a stabiliser against the crystallisation of KHT or other organic acids without causing protein haze.

In a third aspect the invention provides a composition comprising peptides, said peptides having a molar fraction (%) of peptides carrying a carboxy terminal prolyl residue of at least 0.25%. The composition of the third aspect is preferably suitable as a wine or fruit stabiliser. The peptides of the composition of the third aspect of the invention preferably have a molar fraction (%) of peptides carrying a carboxy terminal prolyl residue of at least 0.5%, 1%, 2%, 4%, more preferably at least 5%, 6%, even more preferably at least 10%. A wine stabiliser comprising peptides, having a molar fraction (%) of peptides carrying a carboxy terminal prolyl residue of at least 0.25% may be active as a wine or fruit stabiliser against the crystallisation of KHT or other organic acids without causing protein haze. How said molar fraction of peptides (%) carrying a (carboxy)terminal proline can be determined is extensively described in WO0245523.

The wine or fruit juice stabiliser of the second aspect or the composition of the third aspect of the invention may also comprise one or more additional components, preferably food grade components. The component is preferably suitable for use in wine or fruit juice. Examples of suitable components are carboxy methyl cellulose, meta-tartrate, and Arabic gum.

In a preferred embodiment the wine or fruit stabiliser of the second aspect or the composition of the third aspect of the invention comprises mannoprotein, more preferably mannoprotein from yeast, e.g. Saccharomyces cerevisiae.

The wine or fruit juice stabiliser according to the second aspect or the composition of the third aspect of the invention may be a solid formulation or a liquid formulation. The wine or fruit juice stabiliser according to the second aspect or the composition of the third aspect of the invention finds its preferred use in the stabilisation of wine and fruit juice such as grape juice, or stone fruit juice such as cherry or peach juice. For this reason it is important that the wine or fruit juice stabiliser according to the second aspect or the composition of the third aspect of the invention is devoid of the presence of any harmful microorganism. This is especially important when the wine or fruit juice stabiliser according to the second aspect or the composition of the third aspect of the invention is a liquid. Furthermore the presence of any viable microorganism may have an impact on the storage stability of the wine or fruit juice stabiliser according to the second aspect or the composition of the third aspect of the invention and in the preservation of its efficacy as a stabiliser. The wine or fruit juice stabiliser according to the second aspect or the composition of the third aspect of the invention is preferably packed in a sterile container which may be hermetically closed during transport and storage.

In a fourth aspect the invention provides a process to stabilise wine or fruit juice by preventing or retarding the crystallisation of KHT or other organic acids wherein a wine or fruit juice stabiliser according to the second aspect or the composition of the third aspect of the invention is added to said wine or fruit juice. The wine or fruit juice stabiliser according to the second aspect or the composition of the third aspect of the invention may be added to the wine or fruit juice in all stages of their preparation, for example to wine after bottling, must extracted from the grapes, wine must during fermentation, or wine during aging, or fruit juice before or after filtration.

In a fifth aspect the invention provides a wine or fruit juice comprising the wine or fruit juice stabiliser according to the second aspect or the composition of the third aspect of the invention. The wine or fruit juice according to the fifth aspect of the invention may be stable against crystallisation of KHT or other organic acids, yet may have no, or little, protein haze. The extent of the turbidity due to the protein haze of the wine or fruit juice according to the fifth aspect of the invention may depend on the amount of the wine or fruit juice stabiliser of the second aspect or the composition of the third aspect added to the wine or fruit juice, the incubation time of the composition comprising proteinaceous material with the prolyl-specific protease, and the storage time and temperature of the wine or fruit juice after adding the wine or fruit juice stabiliser.

### EXAMPLES

### Material and Methods

### Nucleation and Crystal Growth of KHT

The nucleation and crystal growth of KHT in wine can be measured and quantified by measuring the time of appearance of crystals in the wine when stored at minus 4° C. A visual inspection is performed daily and the time necessary to detect the appearance of crystals (Tcrys) is expressed in number of days (Moutounet et al. In: Actualités [symbol] nologiques 1999 Vieme Symposium International d'Oenologie de Bordeaux (Lonvaud-Funel ed.)).

### Determination of Prolyl-Specific Protease Activity

The substrate solution is a 2 mM solution of N-carbobenzoxy-glycine-proline-p-nitro anilide (Z-Gly-Pro-pNA; molecular weight 426.43; Bachem) made in a 0.1 M citric acid/0.2 M disodium phosphate buffer pH 5.0 containing 40% dioxan.

To 1 mL of buffer pH 5.0, 250 μl of the substrate solution is added followed by 100 μl of the enzyme solution (larger or smaller volume amounts of enzyme solution should be compensated for by buffer solution). The reaction mixture is incubated at 37° C. and the release of pNA is followed by measuring the absorbance increase at 410 nm.

Activity definition: 1 unit is the enzyme activity that liberates 1 μmol pNA from Z-Gly-Pro-pNA in 1 minute under described reaction conditions. In order to calculate concentrations a molar extinction coefficient (E) of 8,800 M⁻¹ is used.

### Prolyl-Specific Endoprotease

Prolyl-specific endoprotease from Aspergillus niger G306 (deposited at the Centraal Bureau voor Schimmelcultures CBS (CBS109712) on Sep. 10, 2001) was produced as described in WO02/45524.

### Mannoprotein

Mannoproteins were recovered from yeast extract (Maxarome®, DSM Food Specialties) by washing the yeast extract approximately 5-fold with water by means of ultrafiltration (UF) over a 4 kDa Nadir® polyethersulfone hydrophilic membrane (Microdyn-Nadir, Germany) until a concentration of 10% w/v). This is “the mannoprotein solution”.

### LC/MS Analysis of Mannoprotein

UHPLC (ultra high performance liquid chromatography) using an ion trap mass spectrometer (LTQ) (Thermofishert™, Breda, the Netherlands) coupled to an Accela pump (Thermofisher™, Breda, the Netherlands) was used in characterizing the mannoprotein samples produced by the inventive enzyme mixture. The peptides formed were separated using an Agilent SB-C18, 2.1*5 mm (827700-902, Agilent) column in combination with a gradient of 0.1% formic acid in Milli Q water (Millipore, Bedford, Mass., USA; Solution A) and 0.1% formic acid in acetonitrile (Solution B) for elution. The gradient started at 100% of Solution A and increased to 30% of solution B in 45 minutes and was kept at the latter ratio for another 5 minutes. The injection volume used was 50 microliters, the flow rate was 400 microliter per minute and the column temperature was maintained at 30° C. The total peptide concentration of the injected samples was approx. 1 mg/milliliter.

Detailed information on the individual peptides was obtained by using the “scan dependent” MS/MS algorithm which is a characteristic algorithm for an ion trap mass spectrometer.

Full scan analysis was followed by zoom scan analysis for the determination of the charge state of the most intense ion in the full scan mass range. Subsequent MS/MS analysis of the latter ion resulted in partial peptide sequence information, which could be used for database searching using the Sorcerer 2 (SageN, Milpitas, Calif., USA). Data were searched against the Saccharomyces cerevisiae database (SGD). The reliability of the database searching technique was increased by omitting those MS/MS spectra with a probability higher then 0.9.

### Determination of the Molar Fraction of Peptides (%) of Saccharomyces Cerevisiae Mannoprotein, Carrying a Carboxyterminal Proline

LC/MS/MS can be used for the analysis of the C-terminus of a peptide. With an algorithm in which the peptide's molecular mass (analyzed with LC/MS) and its (partial) amino acid sequence (analyzed with LC/MS/MS) are linked with automatic search procedures within protein databanks, complex peptide mixtures can be analyzed. These options have enabled us to quantify the incidence of peptides carrying a carboxy terminal proline residue. Owing to the limitations set by the Agilent SB-C18 column used, only peptides with a molecular weight between roughly 400 and 2000 Dalton are analysed using this technique. Fortunately, in the mannoprotein samples a majority of the peptides have such molecular weights.

To determine the molar fraction of peptides carrying a carboxyterminal proline in the mannoprotein samples before and after incubation with prolyl-specific protease, individual peptide peaks eluting from the Agilent SB-C18 column are selected and partial carboxyterminal amino acid sequences are determined using the techniques specified above. Analysis of at least 100, preferably at least 150 and more preferably between 200 to 300, for example 150 of the most abundant, randomly chosen peptides thus provides insight in the frequency in which peptides carrying a proline residue at the carboxyterminus of the peptide occur. The quotient of the number of peptides found to carry a carboxyterminal proline residue times 100 and the total number of peptides analysed thus provides the molar fraction of peptides (%) carrying a carboxyterminal proline.

### Example 1

### Incubation with Prolyl-Specific Protease

To the mannoprotein solution prolyl-specific endoprotease was added such that the concentration was 1 unit/gram mannoprotein.

The pH of the mannoprotein solution was not changed (pH 5.3). The mannoprotein solution was incubated at 50° C. Samples of 1 mL were drawn at different incubation times. To the remaining 5 mL mannoprotein solution prolyl-specific endoprotease was added such that the concentration was 3 units/gram mannoprotein solution, after which a sample was drawn at t=24 h and t=41 h.

All samples (1 mL) were heated for 1.5 minutes in boiling water and diluted with 9 ml of water. The solution was centrifuged in order to remove any denatured prolyl-specific endoprotease. The samples with double dosage of enzyme had three times as much pellet, which confirmed that the boiling and centrifugation step actually removed the enzyme.

### Testing the Formation of Protein Haze (Turbidity)

Mannoprotein which was treated with prolyl-specific endoprotease was added to a young red wine (Veneto, It) and to a barrel-aged red wine (Gran Feudo reserva, Julian Chivite, Navarra, 2001) in a concentration of 200 mg/L (on dry matter basis). Samples of 25 mL wine were placed at +4° C., and the protein haze was measured as the turbidity by means of a HACH 2100AN turbimeter. Results are shown in Table 1 and 2.

### Results

TABLE 1
Turbidity (NTU) of red wine (Veneto) comprising mannoprotein
(200 mg/L wine), which mannoprotein has been treated with prolyl-
specific endoprotease (1 unit/gram mannoprotein). Turbidity values
are expressed as a function of incubation time of the mannoprotein
with said prolyl-specific endoprotease, and as a function of storage
time of said red wine at 4° C. after adding the prolyl-specific
endoprotease treated mannoprotein.

| | Storage time of the wine | | |
|---|---|---|---|
| | (days) after addition of | | |
| | the prolyl-specific | | |
| | endoprotease treated | | |
| Incubation time of the mannoprotein with | mannoprotein to the wine | | |
| prolyl-specific endoprotease (hours) | 1 day | 3 days | 7 days |
| 0 hours, comparative example | 21.8 | 27.4 | 44 |
| 2 hours | 10.0 | 16.1 | 30.1 |
| 4 hours | 7.8 | 13.3 | 26.2 |
| 7 hours | 6.3 | 11.5 | 23.2 |
| 16 hours | 4.3 | 8.2 | 18 |
| 23 hours | 3.9 | 7.4 | 16.6 |
| 24 hours d* | 2.8 | 5.8 | 13.8 |
| 41 hours d* | 2.3 | 5.1 | 13 |
| Wine without added mannoprotein | 0.3 | 0.4 | 1.6 |

*3 units/gram mannoprotein

The efficacy of the prolyl-specific endoprotease incubated mannoprotein was measured in Listel rosé and French Chardonnay (Tables 3 and 4).

TABLE 2
Turbidity (NTU) of Gran Feudo reserva, Julian Chivite, Navarra, 2001
comprising mannoprotein (200 mg/L wine), which mannoprotein has
been treated with prolyl-specific endoprotease (1 unit/gram mannoprotein).
Turbidity values are expressed as a function of incubation time of the
mannoprotein with said prolyl-specific endoprotease, and as a function
of storage time of said red wine at 4° C. after adding the prolyl-specific
endoprotease treated mannoprotein.

| | Storage time of the wine | | |
|---|---|---|---|
| | (days) after addition of | | |
| | the prolyl-specific | | |
| | endoprotease treated | | |
| Incubation time of the mannoprotein with | mannoprotein to the wine | | |
| prolyl-specific endoprotease (hours) | 1 day | 4 days | 7 days |
| 0 hours, comparative example | 11.5 | 38.5 | 43.3 |
| 2 hours | 8.2 | 32 | 40 |
| 4 hours | 6.6 | 28.7 | 37.2 |
| 7 hours | 5.7 | 18.5 | 21.8 |
| 16 hours | 4.1 | 13.7 | 18.6 |
| 23 hours | 3.5 | 13 | 18.6 |
| Blank wine* | 0.255 | 0.38 | 3.9 |

*wine stored at +4° C.

TABLE 3
Efficacy of mannoprotein as a wine stabiliser after treatment of the mannoprotein
with 1 unit prolyl-specific endoprotease per gram mannoprotein, at different incubation
times of the mannoprotein (hours) with prolyl-specific endoprotease, measured in rosé
wine, expressed as the number of days (d) of the first appearance of crystals (Tcrys) after
storage of the wine at minus 4° C.

| | incubation time of the mannoprotein | | | | | | | |
|---|---|---|---|---|---|---|---|---|
| concentration | with prolyl-specific endoprotease (hours) | | | | | | | |
| mannoprotein | | | | | | | 24 h | 41 h |
| in the wine | | | | | | | 3 units/gram | 3 units/gram |
| (mg/L) | 0 h | 2 h | 4 h | 7 h | 16 h | 23 h | mannoproteins | mannoproteins |
| +0 mg/l | 1 d | 1 d | 1 d | 1 d | 1 d | 1 d | 1 d | 1 d |
| +50 mg/l | <3 d | <3 d | <3 d | <3 d | <3 d | <3 d | <3 d | <3 d |
| +100 mg/l | <3 d | <3 d | <3 d | <3 d | <3 d | <3 d | <3 d | <3 d |
| +200 mg/l | 6 d | 6 d | 7 d | 7 d | 7 d | 4 d | 3 d | 3 d |

TABLE 4
Efficacy of mannoprotein as a wine stabiliser after treatment of the mannoprotein
with 1 unit prolyl-specific endoprotease per gram mannoprotein, at different incubation
times of the mannoprotein (hours) with prolyl-specific endoprotease, measured in
Chardonnay, expressed as the number of days (d) of the first appearance of crystals
(Tcrys) after storage of the wine at minus 4° C.

| | | incubation time of the | | | | | | | |
|---|---|---|---|---|---|---|---|---|---|
| | | mannoprotein with prolyl-specific | | | | | | | |
| | No | endoprotease (hours) | | | | | | | |
| | incubation | | | | | | | 24 h | 41 h |
| concentration | with | | | | | | | (3 units/ | (3 units/ |
| mannoproteins | prolyl- | | | | | | | gram | gram |
| in the wine | specific | | | | | | | manno | manno |
| (mg/L) | endoprotease | 0 h | 2 h | 4 h | 7 h | 16 h | 23 h | proteins) | proteins) |
| 0 mg/l | 1 d | 1 d | 1 d | 1 d | 1 d | 1 d | 1 d | 1 d | 1 d |
| 50 mg/l | 3 d | 3 d | 3 d | 3 d | 3 d | 3 d | 3 d | 3 d | 3 d |
| 100 mg/l | 5 d | 5 d | 5 d | 5 d | 5 d | 6 d | 6 d | 6 d | 6 d |
| 150 mg/l | 10 d | 10 d | 10 d | 12 d | 10 d | 10 d | 10 d | 10 d | 7 d |
| 200 mg/l | 15 d | 11 d | 14 d | 14 d | 12 d | 13 d | 13 d | 11 d | 11 d |

### Example 2

### Incubation with Prolyl-Specific Protease

To the mannoprotein solution isolated prolyl-specific endoprotease was added such that the concentration was 1 unit/gram mannoprotein.

The pH of the mannoprotein solution was not changed (pH 5.3). The mannoprotein solution was incubated at 50° C. Samples of 1 mL were drawn at t=0 h, t=1 h, t=2 h, t=4 h, t=6 h, t=9 h, t=25 h, and t=48 h.

All samples (1 mL) were heated for 1.5 minutes in boiling water and diluted with 16.5 mL of water. The solution was centrifuged in order to remove any denatured prolyl-specific endoprotease.

### Testing the Formation of Protein Haze (Turbidity)

Mannoprotein which was treated with isolated prolyl-specific endoprotease was added to a barrel-aged red wine (Gran Feudo reserve, Julian Chivite, Navarra, 2001) in a concentration of 200 mg/L (on dry matter basis). Samples of 25 mL wine were placed at +4° C., and the protein haze was measured after 1, 4, and 7 days as the turbidity by means of a HACH 2100AN turbimeter. Results are shown in Table 5.

### Results

TABLE 5
Turbidity (NTU) red wine comprising mannoprotein (200 mg/L wine),
which mannoprotein has been treated with prolyl-specific
endoprotease (1 unit/gram mannoprotein). Turbidity values are
expressed as a function of incubation time of the mannoprotein
with said prolyl-specific endoprotease, and as a function of storage
time of said red wine at 4° C. after adding the prolyl-specific
endoprotease treated mannoprotein.

| | Storage time of the wine | | |
|---|---|---|---|
| | (days) after addition | | |
| | of the prolyl-specific | | |
| | endoprotease treated | | |
| Incubation time of the mannoprotein with | mannoprotein to the wine | | |
| prolyl-specific endoprotease (hours) | 1 day | 4 days | 7 days |
| 0 hours (no prolyl-specific endoprotease | 20.1 | 41 | 54.5 |
| added) | | | |
| 0 hours | 17.0 | 39.6 | 47 |
| 1 hours | 6.9 | 32.1 | 40.1 |
| 2 hours | 6.6 | 26.7 | 36.2 |
| 4 hours | 5.2 | 21 | 29.3 |
| 6 hours | 4.6 | 17.7 | 19.9 |
| 9 hours | 4.7 | 13.2 | 16.2 |
| 25 hours | 3.8 | 6.99 | 16 |
| 48 | 3.8 | 6.48 | 13.2 |
| Blank wine* | 0.255 | 0.38 | 3.9 |

*wine stored at +4° C.

The efficacy of the isolated prolyl-specific endoprotease incubated mannoprotein was measured in fresh French Chardonnay. First, part of the wine was cold-stabilised by storage at minus 4° C. whilst the remainder wine was untreated. Next, two wine mixtures were prepared comprising the untreated wine and the cold-stabilised wine: wine mixture A was prepared by mixing 80 parts of the untreated wine with 20 parts of the cold-stabilised wine; mixture B was prepared by mixing 50 parts of the untreated wine with 50 parts of the cold-stabilised wine. Results shown in Tables 6 and 7.

TABLE 6
Efficacy of mannoprotein as a wine stabiliser after treatment of the mannoprotein
with 1 unit prolyl-specific endoprotease per gram mannoprotein, at different incubation
times of the mannoprotein (hours) with isolated prolyl-specific endoprotease, measured in
wine mixture A, expressed as the number of days (d) of the first appearance of crystals
(Tcrys) after storage of the wine at minus 4° C.

| concentration | | incubation time of the mannoprotein | | | | | | | | | | | |
|---|---|---|---|---|---|---|---|---|---|---|---|---|---|
| mannoprotein | | with isolated prolyl-specific endoprotease | | | | | | | | | | | |
| in the wine | | (hours) | | | | | | | | | | | |
| (mg/L) | * | 0 h | 1 h | 2 h | 4 h | 6 h | 9 h | 25 h | 28 h | 31 h | 48 h | 57 h | 72 h |
| 50 mg/L | 3 d | 3 d | 3 d | 3 d | 3 d | 3 d | 3 d | 3 d | 3 d | 3 d | 3 d | 3 d | 3 d |
| 100 mg/L | 3 d | 3 d | 3 d | 3 d | 3 d | 3 d | 3 d | 3 d | 3 d | 3 d | 3 d | 3 d | 3 d |
| 200 mg/L | 12 d | 10 d | 11 d | 11 d | 10 d | 11 d | 10 d | 9 d | 9 d | 12 d | 11 d | 11 d | 10 d |

* no prolyl-specific endoprotease added

TABLE 7
Efficacy of mannoprotein as a wine stabiliser after treatment of the mannoprotein
with 1 unit prolyl-specific endoprotease per gram mannoprotein, at different incubation
times of the mannoprotein (t, in hours) with isolated prolyl-specific endoprotease,
measured in wine mixture B, expressed as the number of days (d) of the first appearance
of crystals (Tcrys) after storage of the wine at minus 4° C.

| concentration | | incubation time of the mannoprotein | | | | | | | | | | | |
|---|---|---|---|---|---|---|---|---|---|---|---|---|---|
| mannoprotein | | with isolated prolyl-specific endoprotease | | | | | | | | | | | |
| in the wine | | (hours) | | | | | | | | | | | |
| (mg/L) | * | 0 h | 1 h | 2 h | 4 h | 6 h | 9 h | 25 h | 28 h | 31 h | 48 h | 57 h | 72 h |
| 50 mg/L | 10 d | 6 d | 4 d | 4 d | 5 d | 4 d | 3 d | 3 d | 4 d | 3 d | 3 d | 3 d | 5 d |
| 100 mg/L | 13 d | 13 d | 12 d | 14 d | 10 d | 14 | 11 d | 14 d | 6 d | 6 d | 14 d | 11 d | 6 d |
| 200 mg/L | 40 d | 38 d | 38 d | 40 d | 18 d | 40 d | 40 d | 24 d | 24 d | 28 d | 21 d | 24 d | 28 d |

* no prolyl-specific endoprotease added

### Example 3

### Molar Incidence of Peptides Carrying Proline as the Carboxy Terminal Residue

The mannoprotein solutions of Example 2 which were incubated with prolyl-specific endoprotease for 4 hours (Sample 1) and 25 hours (Sample 2), as well as the non-incubated mannoprotein solution (Sample 0) were analyzed by LC-MS/MS for the incidence of peptides carrying a carboxy-terminal prolyl residue. Results are shown in Table 8.

TABLE 8
Molar incidence of yeast mannoprotein peptides carrying proline
as the carboxy terminal residue.

| | Number of peptides with | Total number of | |
|---|---|---|---|
| Sample | Proline at C-terminus | peptides determined | Ratio (%) |
| 0 | 0 | 434 | 0 |
| 1 | 24 | 333 | 7 |
| 2 | 17 | 249 | 7 |

1. A process to produce a wine or fruit juice stabiliser comprising contacting a composition comprising proteinaceous material with a prolyl-specific protease.

2. The process according to claim 1, wherein the prolyl-specific protease is a prolyl-specific endoprotease.

3. The process according to claim 1, wherein the proteinaceous material is mannoprotein.

4. The process according to claim 1, wherein the proteinaceous material comprises a peptide mixture with a molecular weight ≧3 kDa and ≦10 kDa and wherein the amount of said peptide mixture is at least 2.5% w/w relative to said composition based on total dry weight.

5. The process according to claim 1, wherein the wine is aged on oak.

6. The process according to claim 1, wherein the wine is red wine.

7. The process according to claim 1, wherein the temperature is from 5 to 120° C.

8. The process according to claim 1, wherein the pH is from 2 to 10.

9. The process according to claim 1, wherein the contacting is carried out for a period from 1 minute to 1 month.

10. The process according to claim 1, wherein the amount of prolyl-specific protease is from 0.001 to 1000 units of prolyl-specific protease activity per gram proteinaceous material, whereby the activity is determined by an activity measurement using Z-Gly-Pro-pNA as a substrate.

11. The process according to claim 1, including inactivation after the contacting.

12. The process according to claim 1, including after the contacting first an inactivation and secondly a solid-liquid separation.

13. The process according to claim 1, wherein the prolyl-specific protease is an isolated or purified prolyl-specific protease.

14. Wine or fruit juice stabiliser, obtainable by the process according to claim 1.

15. A composition comprising one or more peptides, said peptides having a molar fraction (%) of peptides carrying a carboxy terminal prolyl residue of at least 0.25%.

16. A process to stabilise wine or fruit juice by preventing and/or retarding the crystallisation of KHT and/or other organic acids comprising adding a wine or fruit juice stabiliser according to claim 14 to said wine or fruit juice.

17. Wine or fruit juice comprising a wine or fruit juice stabiliser according to claim 14.

18. A process to stabilise wine or fruit juice by preventing and/or retarding the crystallisation of KHT and/or other organic acids comprising adding a composition according to claim 15 to said wine or fruit juice.

19. Wine or fruit juice comprising a composition according to claim 15.
